(19) United States
(12) Patent Application Publication
(10) Pub. No.: US 2015/0206539 A1
(43) Pub. Date: Jul. 23, 2015

(54) ENHANCED HUMAN MACHINE INTERFACE THROUGH HYBRID WORD RECOGNITION AND DYNAMIC SPEECH SYNTHESIS TUNING

(71) Applicant: IMS SOLUTIONS, INC., Schaumburg, IL (US)

(72) Inventors: David Neil Campbell, Oakville (CA); Robert Andrew Rae, Elmira (CA); Akrem Saad El-Ghazal, Waterloo (CA); Daniel John Vincent Sulpizi, Oakville (CA)

(21) Appl. No.: 14/296,044

(22) Filed: Jun. 4, 2014

Related U.S. Application Data
(60) Provisional application No. 61/830,789, filed on Jun. 4, 2013.

(51) Int. Cl. G10L 17/22; G10L 13/08; G10L 15/08

(52) U.S. Cl. CPC G10L 17/22; G10L 15/08; G10L 13/08

(57) ABSTRACT

A human machine interface enables human users to interact with a machine by inputting auditory and/or textual data. The interface and corresponding method perform efficient look up of words, corresponding to inputted human data, which are stored in a domain database. The robustness of a speech synthesis engine is enhanced by updating the deployed pronunciation vocabulary dynamically. The architecture of the preferred embodiment of the former method includes a combination of ensemble matching, clustering, and rearrangement methods. The latter method involves retrieving suggested phonetic pronunciations for words unknown to the speech synthesis engine and verifying those through a manual or autonomous process.

### BACKGROUND OF THE INVENTION

This application relates to enhanced human-machine interface (HMI), and more specifically two methods for improving user experience when interacting through voice and/or text. The two disclosed methods include a hybrid approach for human input transcription, as well as a robust text to speech (TTS) method capable of dynamic tuning of the speech synthesis process.

Automatic speech transcription of human input such as voice or text, is challenging due to the seemingly infinite domain of possible combinations, slang phrases, abbreviations, invented or derived phrases, and cultural dialects. Modern cloud-based recognition tools provide a powerful and affordable solution to the aforementioned problems. Nonetheless, they are typically inadequate when applied within a specific domain of application. As a result, efficient post-processing methods are required to map the recognition output provided by the aforementioned tools to a subset of words in a specific domain of interest.

Modern text to speech (TTS) technologies offer fairly accurate results where the targeted vocabulary is from a well-established and constrained domain. However, they might perform poorly when applied to more challenging domains containing new or infrequently used words, proper names, or derived phrases. Incorrect pronunciations of such words/phrases can make the product appear simple and naïve. On the other hand, many application domains, such as entertainment and sports, contain words that are transient and short lived in nature. Such volatile environments make it infeasible to employ manual tuning to keep pronunciation vocabularies up-to-date. Accordingly, automatic updating of the pronunciation vocabulary of TTS methods can significantly improve their flexibility and robustness in the aforementioned application domains.

### SUMMARY OF THE INVENTION

Two methods for improving the user experience while interacting through voice and/or text are presented. The first disclosed method is a hybrid word look-up approach to match the potential words produced by a recognizer with a set of possible words in a domain database. The second disclosed method enables dynamic update of pronunciation vocabulary in an on-demand basis for words that are unknown to a speech synthesis system. Together, the two disclosed methods yield a more accurate match for words inputted by a user, as well as more appropriate pronunciation for words spoken by the voice interface, and thus a significantly more user-friendly and natural human machine interaction experience.

### BRIEF DESCRIPTION OF THE DRAWINGS

FIG. 1 schematically illustrates a block diagram overview of the disclosed hybrid word look-up method.

FIG. 2 schematically illustrates a block diagram overview of the disclosed dynamic speech synthesis engine tuning method.

### DETAILED DESCRIPTION OF THE PREFERRED EMBODIMENT

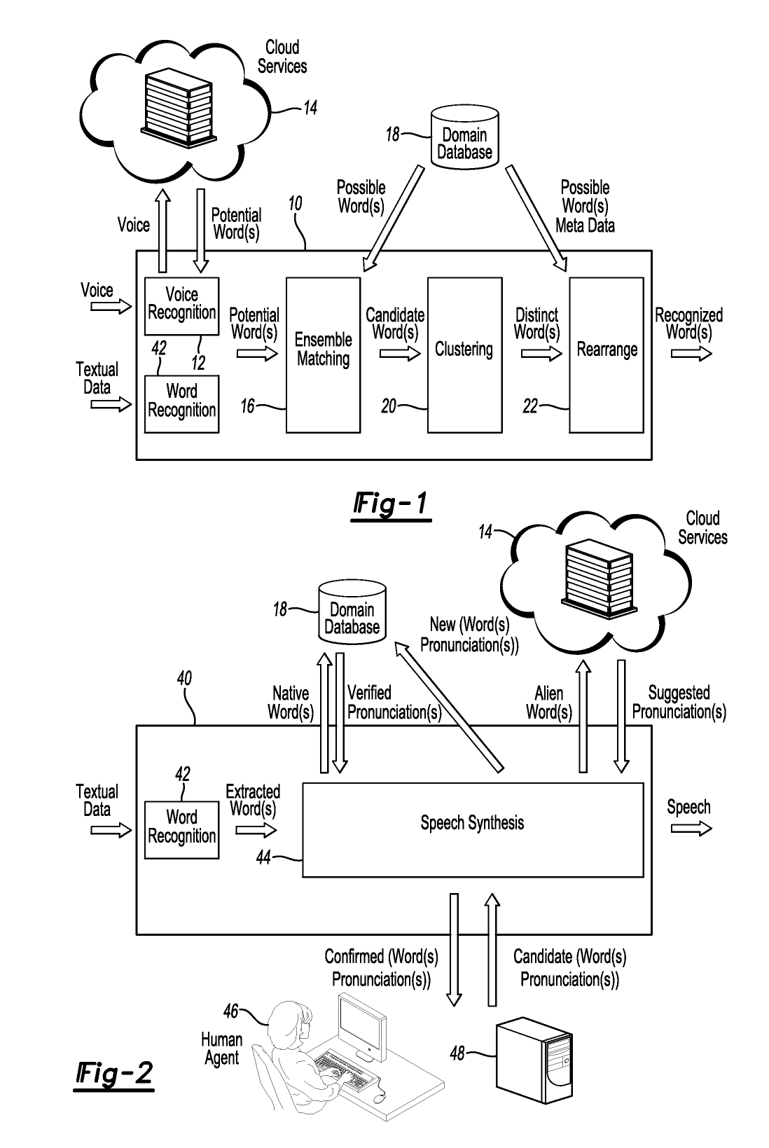

FIG. 1 schematically illustrates the architectural overview for one embodiment of the disclosed hybrid look-up method as a word lookup-up system 10. Depending on its modality, the user input is fed to a voice recognition sub-system 12 or word recognition sub-system 42, which might operate by communicating wirelessly with a cloud-based voice/word recognition server 14, e.g. Google voice recognition engine. A set of potential words outputted by the voice recognition subsystem 12 are matched against the set of possible words, retrieved from a domain database 18, using an ensemble of word matching methods 16.

An ensemble of word matching methods 16 computes the distance between each potential word and each of the possible words. In an exemplary embodiment of the disclosed method, the distance is computed as a weighted aggregate of word distances in a multitude of spaces including the phonetic encoding, such as metaphone and double metaphone, string metric, such as Levenshtein distance, etc. The words are then sorted according to their computed aggregate distances and only a predefined number of top words are outputted as a set of candidate words and fed to a clustering method 20.

A set of candidate words are grouped into two segments by a clustering method 20. The first segment includes candidate words that are considered to be a likely match for the input user voice whereas the second segment contains the unlikely matches. The former category words are identified based on their previously computed aggregate distance by selecting the words that have a distinctly smaller distance. Consequently, the rest of the words are categorized as the second category. In a preferred embodiment of the clustering method a well-known image segmentation approach, called Otsu method, can be used to identify a distinct set of words.

Before being presented to the user as a set of recognized words, a set of distinct words may be rearranged according to one or more of its associated metadata. The metadata are stored along with the set of possible words on a domain database 18 and include features such as frequently of usage, and user-defined or dynamically computed priority/importance, for each word. The rearrangement of words is particularly useful in disambiguation of distinct words with very close distinction level(s).

FIG. 2 schematically illustrates the architectural overview of a speech synthesis system 40 that relies on the disclosed dynamic tuning method to update its vocabulary in an on-demand basis. A word recognition sub-system 42 extracts words contained in the input textual data. A speech synthesis engine 44 then converts the extracted words into a speech, to be played for a user. The speech synthesis engine groups words into two categories. The first category of words, referred to as native words, is those words that already exist in the phonetic vocabulary of a domain database 18. The second category of words, referred to as alien words, is those words that do not exist in the database 18.

For those words identified as alien, a cloud-based resource 14, such as the Collins online dictionary interface, is inquired to obtain one or more pronunciation phonetics suggestions. The obtained pronunciation phonetics could be represented using a phonetics markup language such as IPA or SAMPA. The suggested phonetics are presented to a human agent 46, e.g. a word is displayed on a screen while its suggested pronunciation is played out, to verify their validity. Alternatively, the suggested phonetic pronunciations can be validated using a software agent running on a local server 48. The confirmed pronunciation phonetics, along with their corresponding (previously) alien words, are then added to the domain database 18. This may be done in realtime (i.e. with the user possibly waiting a few seconds while the system confirms the pronunciation with the human agent 46, if there is not already sufficient words to be read to the user while the human verification is performed). Alternatively, this may be done offline, in which the case the user is presented with the best phonetic pronunciation available at the time, which is later validated by the human agent 46 and stored in the domain database 18.

The word-lookup system 10 may be a computer, smartphone or other electronic device with a suitably programmed processor, storage, and appropriate communication hardware. The cloud services 14 and domain database 18 may be a server or groups of servers in communication with the word-lookup system 10, such as via the Internet.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method to perform word look-up based on human input including the steps of:
receiving human input;
performing initial recognition of the human input;
receiving metadata based upon the initial recognition;
prioritizing a plurality of possible words based upon the metadata; and
outputting a first word of the plurality of possible words based upon the prioritization.

2. The method in claim 1 wherein the human input is voice-based.

3. The method in claim 1 wherein the human input is text-based.

4. The method of claim 1 wherein the plurality of possible words and their associated metadata are stored in a domain database.

5. The method of claim 1 wherein recognition of human input voice data is performed using a voice recognizer to produce a set of potential words.

6. The method of claim 5 wherein a human input recognizer may be running locally or on a remote server residing in a cloud.

7. The method of claim 1 wherein a set of potential words are matched against the plurality of possible words using an ensemble of matching methods.

8. The method of claim 7 wherein an ensemble of nearest-neighbor methods operates by minimizing a weighted aggregate of potential to possible word distances.

9. The method of claim 8 wherein the potential to possible word distances are computed in two or more spaces.

10. The method of claim 9 where one space is phonetic encoding.

11. The method of claim 9 where one space is double metaphone encodings.

12. The method of claim 9 where one space is a natural edit distance.

13. The method of claim 1 wherein a set of candidate words is obtained by sorting a set of possible words according to their computed aggregate distance and outputting only a predefined number of top words.

14. The method of claim 1 wherein a set of produced candidate words are processed into two clusters of distinct words, and relevant/irrelevant words.

15. The method of claim 14 wherein the clustering is performed using a segmentation method.

16. The method of claim 14 wherein a set of produced distinct words can be rearranged according to their corresponding metadata of interest to produce a set of recognized words.

17. The method of claim 1 wherein the metadata includes frequency of usage.

18. A method of performing text to speech processing:
receiving text input including a plurality of words;
performing word recognition on the text input;
identifying native words of the plurality of words that already existing in a phonetic vocabulary; and
identifying alien words of the plurality of words that do not exist in the phonetic vocabulary.

19. The method of claim 18 wherein a vocabulary of words and their corresponding verified pronunciation are stored in the phonetic vocabulary.

20. The method of claim 19 further including the steps of dynamically retrieving through a remote server inquiry a suggested phonetic pronunciation for the alien word.

21. The method of claim 20 further including the step of validating a suggested phonetic pronunciation for the alien word by a human agent.

22. The method of claim 21 further including the step of adding the suggested phonetic pronunciation to the phonetic vocabulary based upon being validated by the human agent.

23. The method of claim 20 further including the step of validating a suggested phonetic pronunciation by a software agent.

24. The method of claim 21 further including the step of adding the suggested phonetic pronunciation to the phonetic vocabulary based upon being validated by the software agent.
